(19) United States
(12) Patent Application Publication
(10) Pub. No.: US 2026/0296869 A1
(43) Pub. Date: Oct. 1, 2026

(54) DEVICE FOR EXTRACTING AND DISPENSING LIQUIDS

(71) Applicants: Giovanni SULLUTRONE, Atripalda (IT); Generoso Giuseppe TIRONE, Atripalda (IT); Armando ZAMBELLA, Atripalda (IT)

(72) Inventors: Giovanni SULLUTRONE, Atripalda (IT); Generoso Giuseppe TIRONE, Atripalda (IT); Armando ZAMBELLA, Atripalda (IT)

(21) Appl. No.: 19/477,112

(22) PCT Filed: Apr. 22, 2024
(86) PCT No.: PCT/IB2024/053889

§ 371 Date: Oct. 21, 2025

(30) Foreign Application Priority Data
Apr. 21, 2023 (IT) 102023000007947

(51) Int. Cl. B67D 1/00; B67D 1/10

(52) U.S. Cl. CPC B67D 1/0004; B67D 1/10; B67D 2001/0095

(57) ABSTRACT

A device for extracting and dispensing liquids comprises a hollow needle (3) open at both ends (5, 6) and suitable to be inserted through the stopper of the bottle or container to move a first end (5) of the hollow needle (3) inside the bottle or container, a liquid dispensing conduit (7) connected to the second end (6) of the hollow needle (3) and having an outlet (10) for dispensing the liquid outside the bottle or container, extraction means of the liquid for promoting the rising of the liquid through the hollow needle (3) and for the air extraction to create at least a partial vacuum.

### TECHNICAL FIELD

The present invention finds application into the technical field of devices for food use, suitable for use both in the home and in public or community places, and particularly relates with a device for extracting and dispensing liquids from bottles and other containers, in particular bottles containing wine, spirits or other beverages or food liquids and provided with a closure stopper, without it being necessary to remove the stopper beforehand.

### STATE OF THE ART

As known, alcoholic beverages such as wine and spirits are strongly affected by contact with air, as this contact induces oxidation phenomena which alter their physical and organoleptic properties and which, although immediately can improve their properties, in the medium-long term leads to product deterioration.

On the other hand, both in the home and, increasingly frequently, also in restaurants, it is possible that the content of a bottle is consumed at multiple moments, even distant in time.

In particular, in food sector the habit of serving wine “by the glass”, i.e. pouring the wine into the customer's glass from a bottle not reserved for the customer's table but, on the contrary, from a bottle whose content may be served to different customers, even at different times, is increasingly widespread.

The person responsible for serving the wine or other drink proceeds, between one pour and another, to close the container using a stopper, which can be the original one of the bottle or a stopper to be used specifically to re-cap open bottles.

However, the uncorking phase alone involves the entry of air into the bottle, which will thus come into contact with the liquid, starting its oxidation.

It should also be considered that the stopper, once reapplied, does not guarantee absolute airtightness, so the oxidation processes will continue even after recapping.

As a consequence, the wine, or other liquid contained in the bottle, due to contact with the air for a prolonged time, will be subject to oxidation processes which will alter its properties, so that it is not always possible to guarantee consistency in the quality of the wine product for all pourings.

To at least partially overcome these drawbacks, some solutions have been proposed which aim to reduce the contact of the liquid with the air.

The most widespread solutions are those that involve the use of special caps having systems to expel the air from the bottle.

These solutions have not proven to be particularly effective since they first require the removal of the stopper before each pour, with consequent contact of the wine with the air.

Furthermore, the air extraction procedure is carried out manually, being long and tiring and therefore not always carried out completely, also because these devices do not allow us to know the residual air in the bottle.

Electrically or electronically operated systems for extracting air from the bottle are also known which, however, do not solve the problem related to the need of removing the stopper, with the drawbacks described above.

From US2005/178801 and U.S. Pat. No. 8,225,959 a device is known which allows wine to be extracted from a bottle without removing the cork.

This device comprises a hollow needle suitable to be inserted through the stopper to enter the bottle. The needle is placed in communication with a cartridge containing a stable gas under pressure, for example argon, to insufflate this gas into the bottle and promote the rise of the liquid through the needle, extracting the wine and serving it.

However, this solution has obvious limitations, the first of which is represented by having to continuously replace the gas cartridges, whose duration is generally limited to a single bottle use or at most with an extremely small number of bottles, generally two or at most three 75cc bottles.

The use of cartridges also represents a clear cause of an increase in general and management costs, as well as a special waste that cannot be easily disposed of.

Furthermore, the application of the additional pressure provided by the gas requires that the device has an adequate safety system for locking the stopper to prevent it from being extracted due to the gas pressure.

It follows that this device must have a fairly complex construction, also requiring adequate preparation for use by the operator for avoiding an incorrect connection which could cause damage to people and/or things if the stopper inadvertently came out.

Furthermore, the device is essentially of a mechanical type, without electronic parts which in any case allow correct management of the various operating parameters, so that it is not possible to proceed with a controlled and precise dispensing of the drink.

CN110921608 discloses a device for dispensing wine from a bottle wherein the extraction of the wine is carried out by an electric pump connected to a tapping needle. The extraction of the wine occurs without the simultaneous extraction of air, with the consequence that the wine remaining in the bottle will stay in contact with the air, favoring the oxidative processes which are one of the causes of the deterioration of the organoleptic properties of the wine.

### SCOPE OF THE INVENTION

The object of the present invention is to overcome the above drawbacks by providing a device for extracting and dispensing liquids which is characterized by high efficiency and relative cost-effectiveness.

A particular object is to provide a device for extracting and dispensing liquids, in particular wine, spirits and food liquids in general, which allows the liquid to be extracted from a bottle or other container equipped with a stopper without removing the stopper itself, to prevent any contact of the liquid with the air, avoiding oxidation processes inside the bottle.

Yet another object is to provide a device for extracting and dispensing liquids having high autonomy and which can also be used with more than one bottle, in particular with a large number of bottles, without having to proceed with refills of any kind or in any case without producing waste.

Yet another object is to provide a device for extracting and dispensing liquids with a simple construction and therefore high reliability and which at the same time does not require particular efforts or specific expertise for its use.

Yet another object is to provide a device for extracting and dispensing liquids which allows to control and regulate the amount of liquid extracted at each cycle.

Yet another object is to provide a device for extracting and dispensing liquids which allows to produce at least a partial vacuum inside the bottle even after each extraction for correct conservation of the contents, allowing the drink to be dispensed at multiple times and essentially always guaranteeing the same quality.

Not the least object is to provide a device extracting and dispensing liquids which has high interactivity.

These objects, as well as others which will become more apparent hereinafter, are obtained by a device for extracting and dispensing liquids which, according to claim 1, comprises a hollow needle open at both ends and suitable to be inserted through the stopper of the bottle or container for moving a first of said ends of said hollow needle inside the bottle or container, a liquid dispensing conduit connected to the second of said ends of said hollow needle and having an outlet for extracting the liquid outside of the bottle or container and extraction means for liquid extraction suitable both to extract the liquid from the inside of the bottle or container to promote the rising of the liquid into said hollow needle and the subsequent passage into said dispensing conduit for the liquid flow from the inlet to said outlet of said dispensing conduit and to extract air from inside the bottle or container to create at least partial vacuum.

In this way, the dispensing of wine or other liquid may be associated with a simultaneous removal of air from inside the bottle to create at least partial vacuum, so as to have ideal conditions inside the bottle or container to protect the liquid from oxidation, preserving its organoleptic features.

Advantageously, the flow of the exiting liquid will be obtained as a result of the action of an electric pump or micropump, therefore in a controllable manner, so as to eliminate the risk of sudden leaks from the stopper, also considerably simplifying the structure of the device as it will not be necessary provide caging systems for the stopper itself.

Furthermore, the use of the electric micropump will guarantee high autonomy of the device, which can be used for a large number of bottles with a single recharge of the electrical power supply means, which could for example be rechargeable batteries.

As a consequence, it will be sufficient to proceed with recharging the power supplies but without the need to purchase spare parts, with economic benefits and waste management advantages as well.

Advantageously, the extraction means may also comprise a second electric micropump fluidly connected to the hollow needle and capable of extracting air from inside the bottle or container to create at least partial vacuum, allowing the controlled extraction of the air.

Particularly advantageous alternative embodiments of the device are obtained in accordance with the dependent claims.

### BRIEF DESCRIPTION OF DRAWINGS

Further features and advantages of the invention will become more apparent in light of a detailed description of a preferred but not exclusive embodiments of the device according to the invention, shown by way of non-limiting example with the aid of the attached drawing tables wherein:

FIG. 1 is a simplified side view of the device provided with two selectively applicable needles;

FIG. 2, FIG. 3, FIG. 4 and FIG. 5 each represents in a simplified way a side sectional view of the device according to four different variants.

FIG. 6 is a side view of the device according to a further variant;

FIG. 7 is a view of a first accessory adapted to be applied to the device according to the invention; and

FIG. 8 is a view of a second accessory adapted to be applied to the device according to the invention.

### BEST MODE OF CARRYING OUT THE INVENTION

With reference to the attached figures, a preferred but not exclusive embodiment of a device for extracting and dispensing liquids is shown, particularly suitable for use in combination with a bottle containing wine and equipped with a stopper made of cork, silicone or other synthetic material usually used instead of cork.

However, it is understood that the device may also be used for various liquids, such as beer, spirits or other liquids intended for food or non-food consumption.

The dimensions, shape and capacity of the bottle are not limiting aspects of the present invention, as the structure of the device and of the components thereof may be modified according to the needs and intended use, without thereby departing from the scope of protection of the present invention.

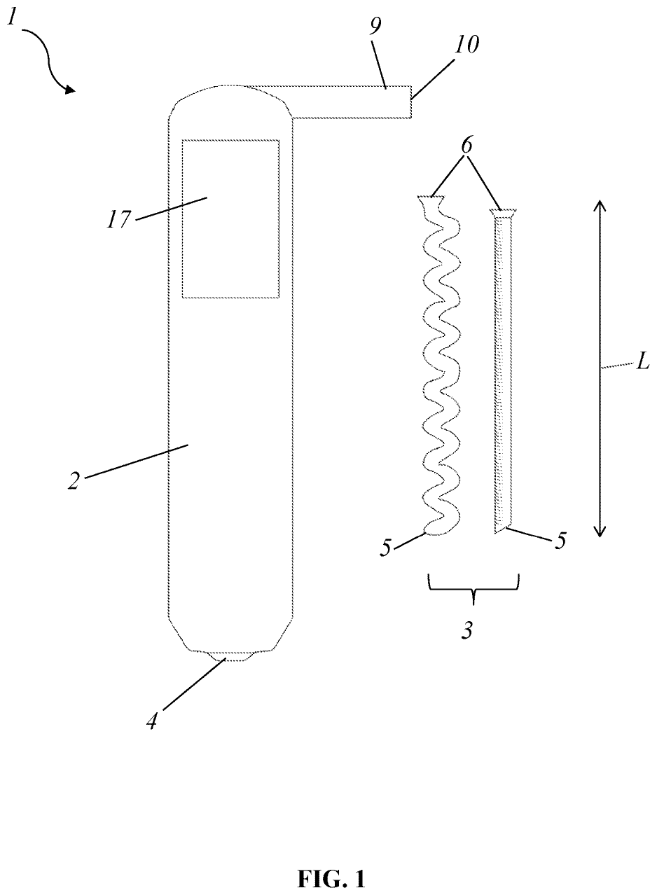

FIG. 1 shows, in a simplified manner, a general, preferred but not exclusive embodiment of the device, indicated globally with 1, which comprises a containment shell 2 with a substantially elongated shape and which will preferably have such a size as to allow it to be easily gripped and held by a user.

The containment shell 2 may also be provided with a covering or skin cover for its aesthetic customization.

The containment shell 2 is provided with a hollow needle 3 adapted to be applied in a fixed or removable manner to the containment shell 2 to project therefrom along a longitudinal direction.

In a first embodiment, preferred but not exclusive, the hollow needle 3 is a cannula needle with a substantially rectilinear shape, whose length L may also be selected depending on the size of the bottles with which it is to be used.

Generally speaking, the length L of the hollow needle 3 may be between 10 cm and 30 cm, also depending on the bottle for which it is designed, with minimum values which will necessarily be greater than the dimensions of common cork stoppers, usually comprised in 35-50 mm.

By way of example, for use with a 75cc bottle of wine, the needle may have a length of approximately 20-25 cm to move its lower end, once completely inserted, to a sufficient distance from the bottom, allowing to extract almost all the contents, possibly leaving a residue of liquid equal to a single dispensing, as the dispensing of the last glass can be carried out by uncorking the bottle.

The inner diameter of the inner cavity of the hollow needle 3 will instead preferably be equal to 15-18 G.

Optionally, the hollow needle 3 may be applied in a removable manner to the containment shell 2 and may be selected among a series of hollow needles having different lengths and/or inner diameters.

The containment shell 2 will possibly be provided with a coupling 4 for the removable connection of the hollow needle 3.

According to a second embodiment, the hollow needle 3 will have a spiral shape and also in this case it can be applied to the containment shell 2 in a fixed or removable manner by means of its connection to the coupling 4.

In case of a removable coupling, it will be possible to select the most appropriate hollow needle 3 to be used from a set of hollow needles which may be different in shape, for example cannula needles and/or spiral needles, and/or in length L and/or in the inner diameter.

Regardless of its configuration, the hollow needle 3 will be open at both ends, with a first end 5 preferably pointed or cut-shaped to allow its insertion into the bottle through its stopper, and a second end 6, also open for allowing the passage of the liquid.

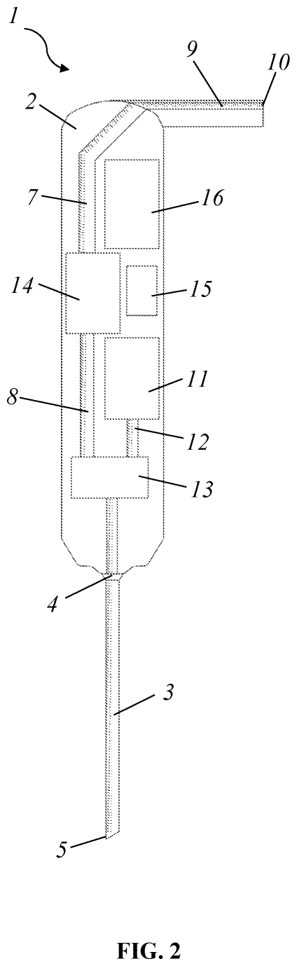

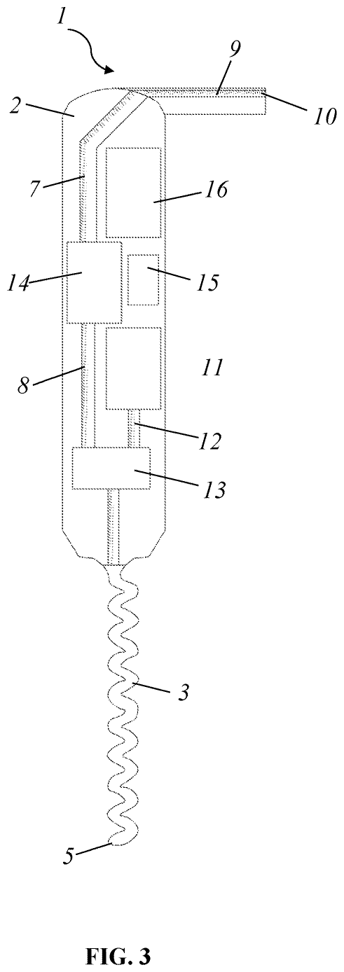

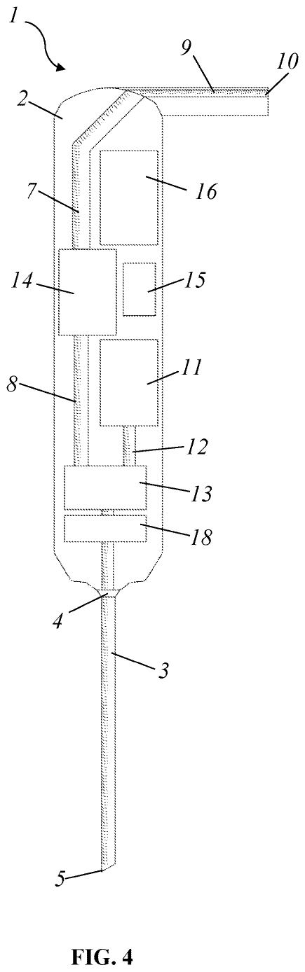

FIG. 2 shows a first variant of the device 1 in a simplified form, from which it is visible a liquid dispensing conduit 7 which is connected to the second end 6 of the hollow needle 3 and which has an initial section 8 inside the containment shell 2 and a final section 9, possibly but not necessarily flexible, which protrudes externally from the containment shell 2, on the side longitudinally opposite to the hollow needle 3.

The final section 9 is provided with an outlet 10 for dispensing the liquid outside the bottle, so that it can be poured directly into the glass or other suitably prepared container.

The dispensing conduit 7 is associated with liquid extraction means designed to promote the rising of the liquid through the hollow needle 3 and along the dispensing conduit 7 itself up to its outlet 10.

The extraction means first of all comprise a first electric micropump 14 housed in the containment shell 2 and placed downstream of the first end 5 of the hollow needle 3, with respect to the rising direction of the liquid flow along the hollow needle 3.

The task of the first micropump 14 will be to promote the rising flow of the liquid from the inlet to outlet 10 of the delivery duct 7.

The extraction means also comprise a second electric micropump 11 designed to extract air from inside the bottle or container to determine a degree of partial or total vacuum, thus almost completely removing the air from the bottle.

The second electric micropump 11 has an air intake conduit 12 in fluid communication with the second end 6 of the hollow needle 3.

Furthermore, inside the containment shell 2 there is a flow diverter 13 suitable for connecting the second end 6 of the hollow needle 3 both with the inlet of the dispensing conduit 7 and with the air intake conduit 12 to keep separated the respective flows.

To this end, the flow diverter 13 has at its inside an electronically controlled solenoid valve which will manage the flow of liquid and air through the selective opening of the dispensing conduit 7 and of the air intake conduit 12.

According to a variant not illustrated, a single electric micropump can be provided, capable of carrying out both the extraction of the liquid and that of the air and having for this purpose two sampling ducts suitable for being placed in fluid connection with the dispensing conduit 7 and the air intake conduit 12 or a single sampling duct suitable to be placed in fluid connection selectively with the dispensing conduit 7 and with the air intake conduit 12.

The electrical power supply of the two micropumps 11, 14 or of the single micropump may be obtained by means of one or more batteries 15, which can be either disposable or rechargeable and which can be housed in the containment shell 2 in a removable manner, to allow its replacement, or even fixed, in this case providing a charging port for connection to an electrical grid or other charging system.

Moreover, the containment shell 2 houses a microcontroller 16 for controlling and/or regulating the operating parameters of the micropumps 11, 14, which can be read on a display 17 placed on the outer side surface of the containment shell 2, as visible from FIG. 1.

The microcontroller 16 will also control the solenoid valve of the flow diverter 13 based on the cycle set for the liquid and air extraction operations.

FIG. 3 shows a variant of the device 1 which differs from the previous one in that it uses a hollow needle 3 having a spiral shape.

Also in this case the hollow needle 3 may be applied to the containment shell 2 in a fixed or removable manner by connecting it to the coupling 4.

In both the above embodiments, the insertion of the hollow needle 3 through the stopper may be carried out manually, by pressing the hollow needle 3 if it is a cannula needle or by screwing it if it is a spiral needle.

According to alternative variants, shown in FIGS. 4 and 5, the containment shell 2 will house an electric motor 18, for example an orbital motor, connected to the hollow needle 3 and which will promote the rotation thereof around its axis, so as to significantly facilitate its insertion, making both the insertion and extraction of the hollow needle 3 particularly easy and fast.

The power supply of the electric motor 18 may be delegated to the same electrical power supply means provided for the micropumps 11, 14 or to similar dedicated power supply means.

The control of the electric motor 18 may be provided by the same microcontroller 16 and for this purpose the device 1 may be provided with one or more commands for operating the micropumps 11, 14 and the electric motor 18, which can be physical buttons or commands selectable on the display 17 and which, again, can be dedicated to each of the above elements or designed to allow the simultaneous operation of the micropumps 11, 14 and the possible electric motor 18.

The microcontroller 16 may also allow the regulation of the amount of liquid to be dispensed at each single cycle, interrupting the action of the first micropump 14 following the extraction of the predetermined amount.

In particular, the microcontroller 16 may be provided with a timer suitable of stopping the first electric micropump 14 after a predetermined time corresponding to the time needed to extract the predetermined amount of liquid and which will also vary depending on the capacity of the micropump 14.

Furthermore, via the microcontroller 16 it will also be possible to regulate the number of liquid dispensing cycles, and therefore of activation cycles of the first electric micropump 14 before the second micropump 11 is activated for air extraction.

In this way it will be possible to have multiple consecutive spills without it being necessary to extract air after each single extraction.

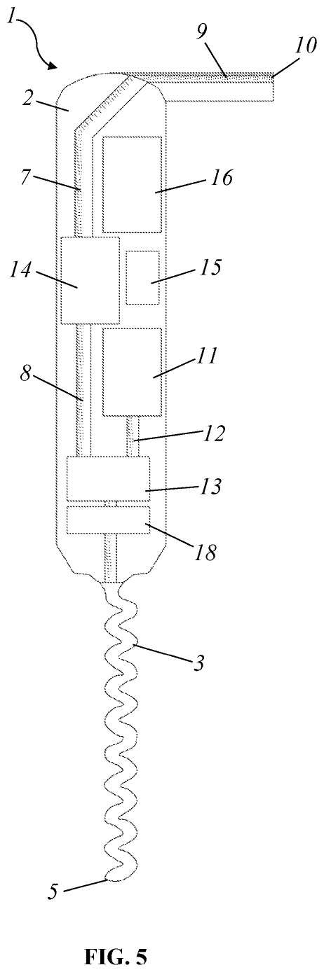

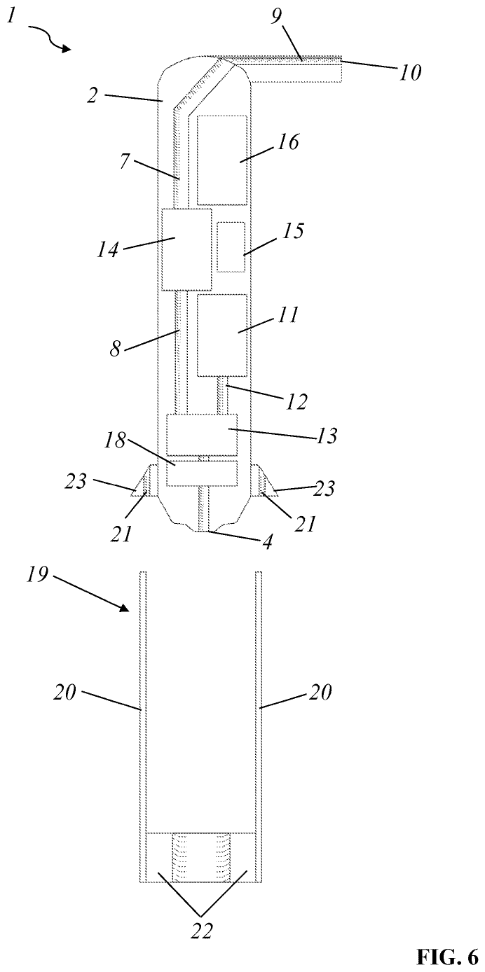

FIG. 6 shows a variant of the device 1 which differs from the above versions essentially for the presence of a guide element 19 suitable to be removably anchored to the bottle or container which to dispensing the liquid from and which has one or more sliding guides 20 for corresponding counter-guides 21 associated with the containment shell 2.

The guide element 19 will preferably be formed by two parallel guides 20 which end with two semicircles 22, which can be adjusted based on the size and diameter of the bottle neck, tightening and securing themselves thereto.

The two guides 20 will be inserted into the two couplings 23 made on the sides of the device 1 and which will be provided with counter-guides 21, to allow, once inserted, to comfortably push the hollow needle 3 inside the stopper, then holding the device 1 in place, limiting the risk of damaging the needle and/or bottle.

The use of the guide element 19 will be particularly designed for the version without the orbital electric motor 18.

The guide element 19, in addition to constrain the insertion of the hollow needle 3, also helps, while the device 1 is being used, to secure it on the bottle so as it doesn't break or fall.

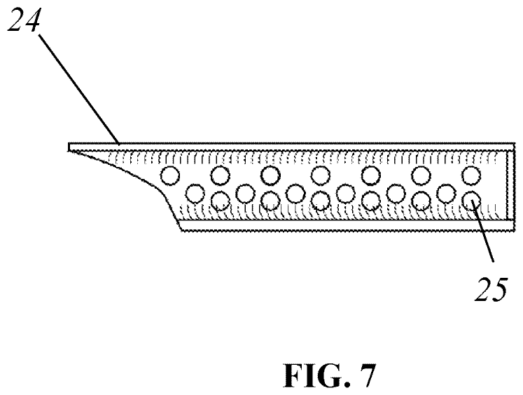

FIG. 7 shows a further accessory represented by a nozzle 24 applied or adapted to be removably applied to the outlet 10 of the dispensing conduit 7. The nozzle 24, preferably made of glass, contains at its inside a plurality of glass microspheres 25 which will allow slow aeration of the liquid being dispensed. The ends of the nozzle 24 will have a mesh to contain the microspheres 25.

In this way the liquid, in particular wine, will pass through the nozzle 24 before ending up in the glass, reducing the risk of incorrect or too fast oxygenation and maximizing the organoleptic qualities.

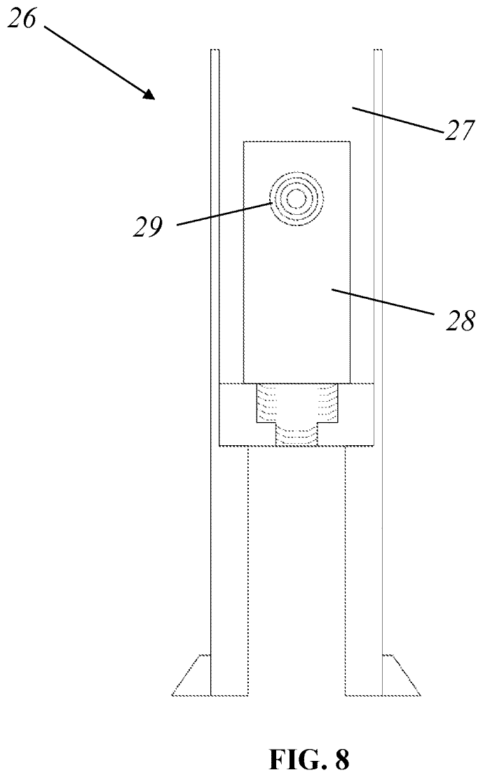

FIG. 8 shows yet another accessory represented by a wireless charging base 26 which allows charging by holding the device 1 in position, making it always ready for use.

The charging base 26 is designed to be positioned on a support surface waiting for the device 1. The device 1 will be placed vertically, using the same couplings 23 for the sliding of the guides 20, so as to keep it exactly on the area of charging inside a proper seat 27.

The charging base may accommodate a single device 1 or to have multiple charging slots. A rechargeable battery 15 of the wireless type will be present inside the device 1, while inside the charging base 26 there will be a charging area 28, for example with inductive charging using a charging coil 29 or using any other kind of known or unknown technologies, on which the device 1 will be placed to recharge its battery 15.

Advantageously, the device 1 may be associated with a software application which will allow a user to control and/or adjust the various operating parameters, such as for example the duration of each extraction cycle, also for the purpose of regulating the amount of extracted beverage at each cycle, the number of liquid extractions to be caried out before proceeding with the air extraction, or even to check the amount of residual drink in each bottle.

To this aim, the microcontroller 16 may be associated with remote communication elements designed to exchange data with the device on which the application is installed, such as a smartphone or other mobile communication device.

The application may be characterized by several main functions, such as the possibility of managing bottles of wine through a virtual cellar, keeping track of the amount left in each bottle, keeping track of the time elapsed since opening, displaying the remaining time for the conservation of a certain bottle, possibility to order bottles based on the residual amount or the time elapsed since opening.

Furthermore, the application will allow the device 1 to be used remotely, allowing the user to activate and stop the extraction means.

Furthermore, it will allow data to be exchanged with device 1, via a wireless module integrated into the microcontroller 16 which will communicate with the sensors associated with the various components to receive data and with all the physical switches to give instructions to device 1.

The software application may also be implemented with further auxiliary functions, such as, by way of example, recognition of the label of a bottle to save it more quickly, possibility of recommending a wine to the customer based on previous preferences, display of the label and of the history of a certain bottle, possibility of sending a notification when a bottle has been opened for a certain time, certify through a stamp that the bottle has been stored correctly.

Furthermore, the software application may be organized with a section reserved to the owner, having all the functions, and a section reserved to the specific user/diner, with only scannable information on the wines, pairings and personal tasting profile.

What is claimed is:

1. A device for extracting and dispensing liquids, wherein an amount of liquid is contained in a bottle or container having a stopper, which device comprises:
a hollow needle (3) a first end (5) and a second end (6) and open at both said first end and second end (5, 6) and suitable to be inserted through the stopper of the bottle or container to move the first end of said hollow needle (3) inside the bottle or container;
a liquid dispensing conduit (7) connected to the second (6) of said hollow needle (3) and having an outlet (10) for dispensing the liquid outside the bottle or container;
extraction means of liquids suitable for promoting the rising of the liquid through said hollow needle (3) and said outlet (10) of said dispensing conduit (7);
wherein said extraction means are of the electric type and suitable both for withdrawing the liquid from inside the bottle or container to promote the rising of the liquid into said hollow needle (3) and the subsequent passage into said dispensing conduit (7) for the flow of the liquid from the inlet to the said outlet (10) of said dispensing conduit (7) and the air extraction from inside the bottle or container to create at least a partial vacuum.

2. The device as claimed in claim 1, wherein said extraction means comprise a first electric micropump (14) fluidly connected with said hollow needle (3) and with said dispensing conduit (7) and suitable for delivering the liquid from the inside the bottle or container to promote the rising of the liquid into said hollow needle (3) and the subsequent flow into said dispensing conduit (7) for the flow of the liquid from the inlet to said outlet (10) of said dispensing conduit (7).

3. The device as claimed in claim 2, wherein said extraction means comprise a second electric micropump (11) fluidly connected to said hollow needle (3) and suitable to extract air from the inside of the bottle or container to create an at least partial vacuum.

4. The device as claimed in claim 3, wherein said second electric micropump (11) has an air intake conduit (12) in fluid communication with said second end (6) of said hollow needle (3).

5. The device as claimed in claim 4, wherein said extraction means comprise a single electric micropump suitable both for extracting the liquid from inside the bottle or container for the dispensing the liquid and for extracting air for creating an at least partial vacuum, said single electric micropump having liquid and air dispensing conduit in fluid connection respectively with the inlet of said dispensing conduit (7) and with the inlet of said air intake conduit (12).

6. The device as claimed in claim 5, comprising a flow diverter (13) suitable for connecting said second end (5) of said hollow needle (3) with the inlet of said dispensing conduit (7) and with the inlet of said air intake conduit (12) and to keep the respective flows separate.

7. The device as claimed in claim 1, wherein said hollow needle (3) is a straight cannula needle.

8. The device as claimed in claim 1, wherein said hollow needle (3) is a spiral needle.

9. The device as claimed in claim 1, wherein said hollow needle (3) is removably applied to said dispensing conduit (7) and is selected from a group comprising at least one cannula needle and one spiral needle.

10. The device as claimed in claim 1, comprising an orbital electric motor (18) connected to said hollow needle (3) to promote the rotation of said hollow needle (3) about the axis of said electric motor (18).

11. The device as claimed in claim 3, comprising a containment shell (2) having an outer surface and which houses said first micropump (14) and/or said second micropump (11) and said dispensing conduit (7).

12. The device as claimed in claim 11, wherein said containment shell (2) is provided with a coupling (4) for the removable connection of said hollow needle (3) and its connection with said dispensing conduit (7).

13. The device as claimed in claim 11, wherein said containment shell (2) houses a microcontroller (16) for controlling said first micropump (14) and said second micropump (11) and at least one power battery (15).

14. The device as claimed in claim 11, wherein said containment shell (2) is provided with a display (17) placed on the outer surface for controlling the operating parameters.

15. The device as claimed in claim 11, comprising a guide element (19) suitable to be removably anchored to the bottle or container from which to dispense the liquid, said guide element (19) having one or multiple sliding guides (20) for corresponding counter-guides (21) associated with said containment shell (2).

16. The device as claimed in claim 1, comprising a nozzle (24) applied to said outlet (10) of said dispensing conduit (7) and having glass microspheres (25) thereinside.

17. (canceled)

18. The device as claimed in claim 1, comprising a containment shell (2) which houses said single micropump, said dispensing conduit (7) and said electric orbital motor (18).

19. The device as claimed in claim 5, comprising a containment shell (2) having an outer surface and which houses said single micropump, a microcontroller (16) for controlling said single micropump and at least one power battery (15).
